(19) United States
(12) Patent Application Publication
(10) Pub. No.: US 2005/0272024 A1
(43) Pub. Date: Dec. 8, 2005

(54) Automated training and evaluation

(75) Inventors: Jeffrey D. Ullman, Stanford, CA (US); Ramana V. Yerneni, Cupertino, CA (US); Alan Lee Beck, Campbell, CA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Gradiance Corporation, Stanford, CA (US)

(21) Appl. No.: 11/146,515

(22) Filed: Jun. 7, 2005

Related U.S. Application Data
(60) Provisional application No. 60/577,908, filed on Jun. 8, 2004.

(51) Int. Cl. G09B 3/00; G09B 7/00

(52) U.S. Cl. 434/362; 434/322; 434/350

(57) ABSTRACT

In order to provide improved training and testing, a solution to a given problem is accepted from a user. The solution is tested to ensure that it is syntactically and semantically correct. If it is not, then information is displayed to the user regarding the problems. Evaluation cases are used to test semantic correctness. When an evaluation case indicates that a semantic problem has been encountered, the evaluation case is not presented to the user. Rather a similar training case is presented which is calculated to demonstrate the same semantic problem as the evaluation case. Thus, the user can be helped to understand the issue without being provided with the evaluation cases on which the solution is being tested.

### CROSS REFERENCE TO RELATED APPLICATION

This application claims the benefit of U.S. Provisional Application No. 60/577,908, entitled “MANIPULATION OF TEST DATA FOR AUTOMATED GRADING OF ASSIGNMENTS,” filed on Jun. 8, 2004, which is hereby incorporated by reference.

### BACKGROUND OF THE INVENTION

In some educational situations, it is useful for a student to train by practicing the skills the student is being taught, and to be evaluated in the student's performance in doing so. This may be done, in some contexts, by confronting a problem and arriving at a solution. One pedagogical problem is that, in certain situations, a student's solution to a problem does not need to be identical to the instructor's answer to be correct. Determination of correctness of a student's answer may be hard, for example when various logically equivalent correct answers are possible. Simply comparing the submitted answer to see if it exactly matches with the reference answers may not work.

For example, where databases are being taught to a student, the student may be asked to write a database query which corresponds to a given English query. Thus, an instructor can set up a lab project by describing the problem context (e.g., the database schema and the set queries, in English), along with test inputs (e.g., an instance of the database conforming to the schema) and reference answers (e.g., correct SQL queries corresponding to the English queries). In the database example, when a student submits answers to a lab project, some way other than simple comparison to a solution must be found to determine the correctness of the answers

In order to verify the correctness of the students answers, according to some prior art systems, an online/virtual lab project can be created to evaluate the answers to the lab projects that are submitted by the users (i.e., students). In such systems, in order to determine if the answers are correct, the functionality of the answer is tested.

As an example, when teaching students computer programming, it is useful for them to learn by creating programs. The student can be asked to write a program (or query, or macro) that performs some task, and the student's work can then be executed and applied to some set of test data. If the program is correct, then the result of applying the student's work to the test data should match the answer key.

Prior art systems for training students in programming collect the student's program and run it on the appropriate compiler or interpreter. For example, a system to train students in the C programming language takes C language source code provided by the student and uses a C language compiler to compile the program. In some prior art systems, e.g., the Addison-Wesley “MyLab” series of products, the student is then shown the response by the compiler, that is, any errors generated by the compilation of their code, or other messages from the compiler. The student is allowed to try again, and when the program compiles with no errors, to submit the work for grading. The program must then be evaluated by a grader. Only syntactic correctness for compilation is checked by such prior art systems.

Another challenge in online learning applications with respect to providing laboratory exercises is the inability of the applications to provide insightful information about the nature of the errors/mistakes when the submitted answers are incorrect. Students often do not get the exercise right on the first try. Merely letting the users know whether the submitted answers are correct or not is not very useful.

In the example case of a SQL lab project, it would be useful for a student to know what is wrong when his/her submitted SQL query is judged incorrect. Perhaps, the submitted SQL query has syntax errors. In such a case, it is useful for the student to know that there are syntax errors and it would be even more useful if the specific syntax errors can be pointed out. In other cases, the student may have submitted a syntactically correct SQL query, but it is semantically incorrect in the sense that it produces the wrong results.

In the programming example, it is similarly useful to show the student what result his or her work produced on the test data, in order to help the student see the error in the program that the student has written. Another group of prior art systems does just this. These prior art testing systems test the program written by the student on certain test data (perhaps after some baseline has been reached—e.g. after the program has been determined by compilation to be syntactically correct.) If the student's program makes the wrong response to one or more of the test cases, the student is shown that test case. The approach of these prior art systems is to automate not only the handling of the program (e.g. compilation) but also the testing of the functionality of the program. One example of such prior art systems is the Online Web-based Learning (“OWL”) system developed by the University of Massachusetts, which includes a Java programming lab.

However, this approach has a significant problem—the student may learn too much about the test data, and may be able to write a trivial program that produces the correct output but does not solve the underlying problem. In the worst case, if the student has access to the entire corpus of test data, the student can simply work the problem by hand, and then write a program that prints the results that the student has figured out are the desired results for the given input.

Thus, as a simple example, it may be the case that a student is asked to write a program in the C programming language that takes a numerical input x and returns as output the cube root of x. A prior art system as described above would take the program written by the system and, if it compiles, test it on an input value. If the correct value is not output by the program, the prior art system will tell the student (1) the testing input value(s) which were used to test the program, (2) the incorrect output value(s) given by the student's program, and (3) the correct output value(s) which should have been provided by the program.

In such a case, if the student can not fix the program to give the correct value by writing a program which correctly calculates cube roots for any values input to the program, the student may be tempted to, instead, write a program that recognizes the testing input values and outputs the correct output value(s) by consulting a table where the student has stored the correct output value(s) that were provided during the prior evaluation of the student's (incorrect) program. Thus, the student can produce a program that compiles and performs correctly on the testing input values used to evaluate the program but which, in fact, is not a program that will generally performs the calculation requested.

As more complex tasks are generally requested of the student, it will be more obvious that the integrity of the evaluation process may be compromised by such “shortcuts.”

In view of the foregoing deficiencies in existing training and evaluation systems, there is a need for automated training and evaluation that provides helpful feedback to the user without jeopardizing the integrity of the evaluation process.

### SUMMARY OF THE INVENTION

The invention overcomes the challenges of a) ascertaining the correctness of the submitted answers and b) providing useful information about the nature of the errors/mistakes in the cases where the submitted answers are incorrect. Thus, an online learning application with significantly improved effectiveness in providing lab exercises to train and evaluate a user is provided. The invention allows a user's solution to be evaluated on one set of data, and if problems are encountered with the user's solution, feedback can be provided to the user without compromising the ability to retest a revised solution submitted by the user.

According to the inventive techniques, two sets of data are used in interactions with the student user: a training set and an evaluation set. When the student's answer (program, query, etc.) to the problem presented is applied to the training set, the results of this application of the student's answer to the example set are shown to the student. However, the student's actual score on the exercise is based, at least in part, on applying the student's program to the evaluation set, and details regarding the evaluation set are not revealed to the student. In one embodiment, the training set is constructed in such a manner that a student answer that produces errors on the evaluation set will also produce similar errors on the training set. The training set and results can then be used to assist the student in understanding the problem with the student's solution.

Other embodiments, advantages and novel features of the invention may become apparent from the following detailed description of the invention when considered in conjunction with the drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of a configuration of computing systems in which an embodiment of the invention may be implemented;

FIG. 2 is a block diagram of a possible configuration of computing systems in which another embodiment of the invention is implemented; and

FIG. 3 is a flow diagram of a method according to one embodiment of the invention.

### DETAILED DESCRIPTION OF ILLUSTRATIVE EMBODIMENTS

Automated Training And Evaluation

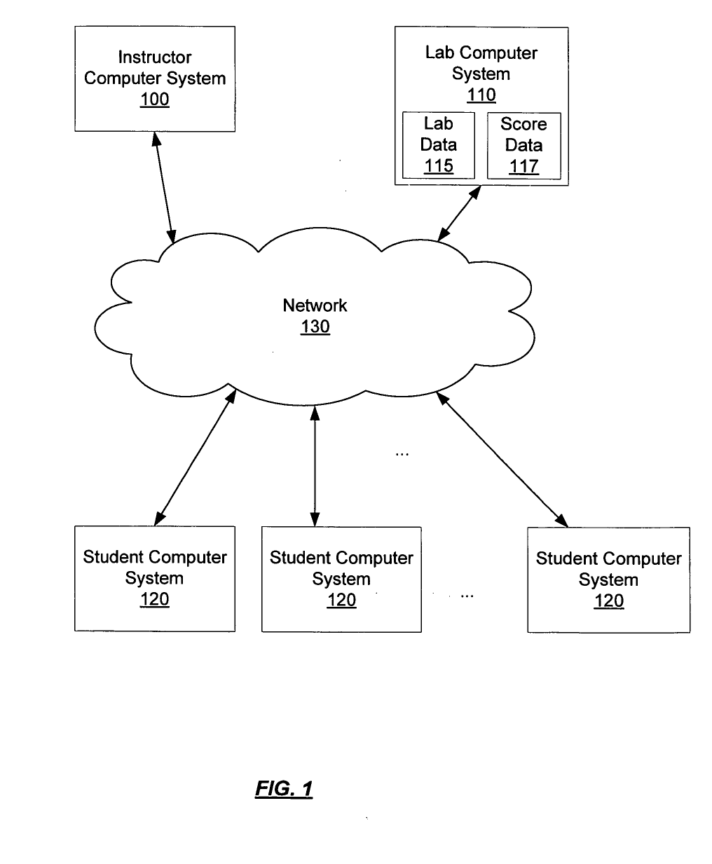

Automated training and evaluation techniques according to the invention allow an instructor to provide training and evaluation of one or more students. FIG. 1 is a block diagram of one possible configuration of computing systems in which the invention may be implemented. As seen in FIG. 1, an instructor, using instructor's computer system 100 can develop and store lab data 115 on a lab computer 110. This lab data 115 is used to provide the students with training and evaluation data. Students can access the lab data 115 via student computer systems 120. When each student completes the lab, score data 117 is stored on the lab computer 110 which can be accessed by the instructor for determining how each the student 120 has performed. The inter-computer interactions are mediated by a network 130, which may be a local area network, the Internet, or some combination of the two. It will be appreciated that the computing systems shown are exemplary, and other means of developing, storing, transmitting and using data are contemplated.

Generally, the student is presented with a problem for which there are one or more correct solutions. The defining characteristic of these solutions is that, if they are correct, when they are applied to evaluation data they achieve a verifiably correct result. Thus, the solution may be any of the following (without limitation): a program, a query, a spreadsheet, a formula, a set of directions, etc.

The result generated can be correct or incorrect. Where, for example, the Structured Query Language (SQL) for database information retrieval is being taught, in one case the instructor sets up a database schema, and assigns the students the task of writing SQL queries corresponding to a set of English language queries. For example, the database schema may describe employee records, and one English language query may be, “Retrieve all records of employees hired in 2002 or 2003.” While there are many correct solutions, each correct solution, when applied to a database, will retrieve the same set of records, though possibly ordered differently.

Generally, a student presented with a problem set by the instructor interacts with an application, creating an answer. When the students create and submit their answer to a problem or question (e.g. SQL queries, a program, etc.) the application evaluates the answer, lets the students know if the answer is correct or incorrect, and provides training information, as described below.

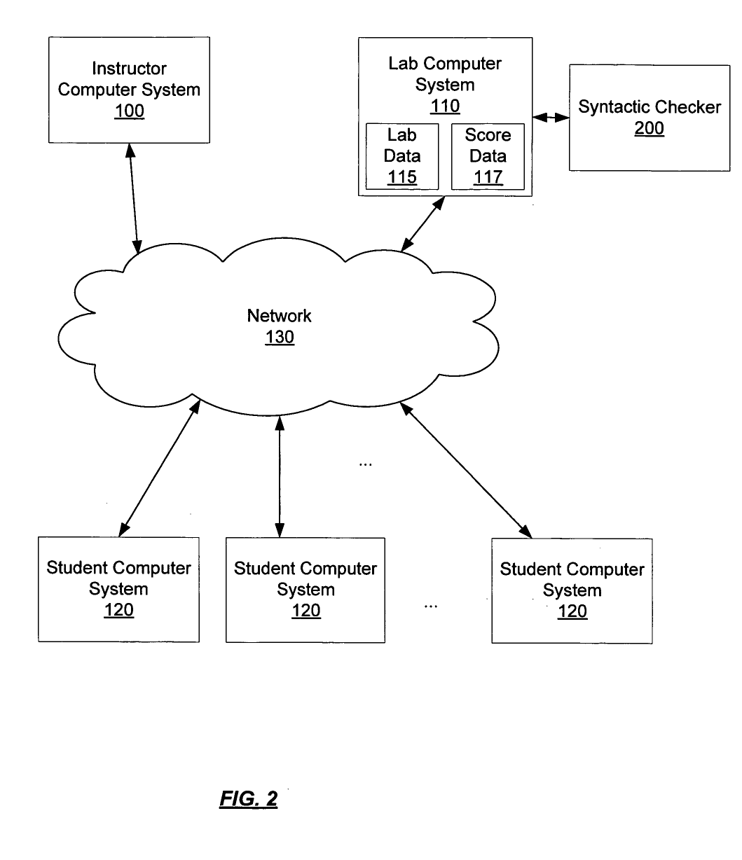

In one embodiment, the application first checks the student's answer syntactically. FIG. 2 is a block diagram of a possible configuration of computing systems in which another embodiment of the invention is implemented. As shown in FIG. 2, a syntactic checker 200 is provided. The syntactic checker 200 is used to check the syntax of the user solution to the problem posed. While the syntactic checker 200 may be part of a system provided in one embodiment of the invention, in another embodiment the functionality of an external syntactic checker is accessed and used by the inventive system. In other embodiments, no syntactic checking is performed. In the SQL example, if the queries are syntactically incorrect, the application returns information pointing out the syntax errors in the submitted queries. In one embodiment, where the student's answer is a program in a compiled programming language, the syntax check is whether the program compiles correctly. In other embodiments, no syntax check is needed, either due to the nature of the problem presented by the instructor or because a syntactic check occurs prior to the submission of the answer. For example, if the lab calls for the student to write compliable code, if the student is asked to submit a compiled version of code to the training/evaluation application, the syntactic check occurs before the answer is submitted, during compiling. In other cases, no syntactic check is required.

The training/evaluation application checks the student's answer semantically. The lab data 115 is used in order to perform this check and present the student with training information regarding any problems with the answer. The lab data 115, in one embodiment, includes training data (also termed “example” data or “sample” data) and evaluation data (also termed “hidden” data). One or more cases may be present in the evaluation data, and one or more cases may be present in the training data. There need not be a one-to-one correspondence between training and evaluation cases. Thus, for example, one training case may highlight problems tested in two different evaluation cases. Similarly, two training cases may highlight problems encountered in one evaluation case.

There may be an evaluation case for which there is no training case. For example, “edge” or “boundary” conditions may need to be tested. In a computer program taking a numerical input, for example, where the program divides by an input number, it may be necessary to test the program's response when the input is zero, because this is a special case. However, there is no way to generate a corresponding training case which is different from the evaluation case but elucidates the same issue. Thus, in such a case, in one embodiment, a message is displayed to the user. The message may simply indicate that a failure has occurred, may describe the failure, or may otherwise provide instruction to the user to help them fix the failure (e.g. through hints).

One or more cases may be present in both the set of evaluation cases and the set of training cases. For example, as discussed above, edge conditions may need to be tested, and in such cases, a case which tests the edge condition may be included in both the evaluation cases and in the training cases.

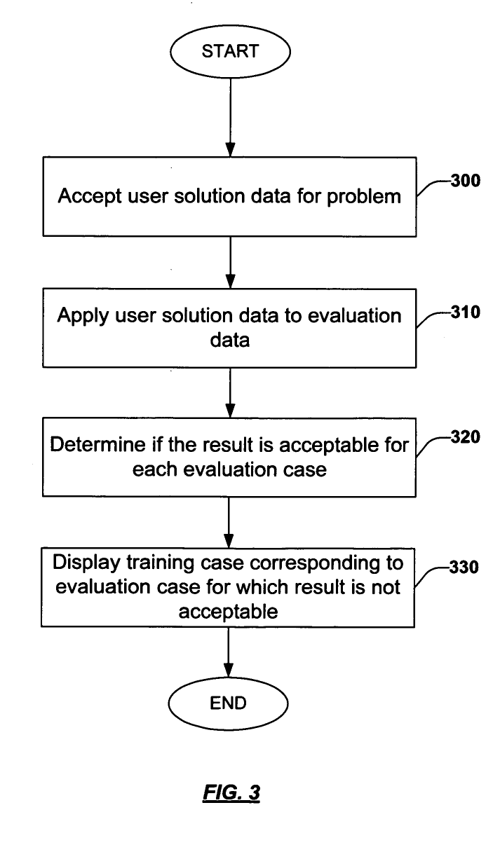

FIG. 3 is a flow diagram of a method according to one embodiment of the invention. As shown in FIG. 3, user-solution data for a problem is accepted from a user, in step 300. The user solution data is then applied one or more evaluation cases, producing corresponding user results, in step 310. For each of these (one or more) corresponding user results, an evaluation is made to determine whether the result is acceptable, step 320. If any result is not acceptable a training case is displayed to the user corresponding to the evaluation case for which an unacceptable result was returned, step 330. Additionally, other explanatory material may be presented to the user. In one embodiment, before the semantic application in step 310, a syntactic evaluation of the user solution data is made, and the result of such syntactic evaluation is presented to the user as well.

The analysis of acceptability in step 320 may be by a simple comparison of the user result with a sample reference result. Alternatively, the analysis of acceptability in step 320 may be by the comparison of the user result with a result from a reference solution. Additionally, the training case may be previously stored or generated on the fly via transformations such as those detailed below.

Training Data And Evaluation Data

In one embodiment, the application uses the evaluation data to determine if the student's answer is correct. If it is not correct, the student is presented with information that allows the student to better understand the problem with the answer. However, this information does not directly describe the evaluation data and the problems detected with the student's answer using the evaluation data. Rather, the information describes another situation in which a similar or identical problem occurs—the training data.

In order to prevent students from “training” their answers to simply pass the test cases that are presented to them (e.g., the training databases that are used to illustrate their errors/mistakes), instructors indicate a separate set of cases, evaluation cases, that will not be used to illustrate errors/mistakes to the students, but will be used to ascertain the correctness of the submitted answers. That is, a submitted answer will not be deemed correct, just because it passes all the sample test cases that are presented to the student to illustrate errors/mistakes. It does have to pass the “hidden” test cases (the evaluation data) that are difficult for the student to “train” their answers to.

In order to obtain the training data, in one embodiment, when the lab project is set up by the instructor, the instructor indicates the training data (e.g. sample database states) that can be used for training purposes. The instructor also indicates correct/reference answers (e.g. in the form of SQL queries that do produce the correct results.)

In one embodiment, an instructor includes both training and evaluation data in the lab data 115. In another embodiment, the training data is obtained on the fly by modifying the evaluation data in such a way that the problem with the answer is elucidated by the training data but the student does not receive enough information to create a “shortcut” answer which would perform properly on the evaluation data without meeting the real goals set by the instructor for the assignment.

Correctness of Performance

As described above, there may be many different correct answers, which provide the requested function on the evaluation data. Additionally, different answers, when applied to the evaluation data, may yield different results, all of which may be correct. In one embodiment, the results from the student's solution as applied to an evaluation case are compared to a stored correct reference result. In another embodiment the results of the student's solution is compared to the results of applying a reference solution to the evaluation case. In both cases, the comparison may be to determine identity (comparing one string to another, character by character) or to determine whether an important similarity is there (comparing a reference set of randomly ordered elements to the set obtained from the student's solution to ensure that they both contain the same elements). Other comparisons are also contemplated—for example, when the results of a solution are voluminous, only certain elements of each result may be compared.

As an example, where a student is being requested to produce a SQL query which corresponds to an English question about data in a database; different queries may yield correct results, and different results may be correct.

In SQL, the results produced by queries are lists of rows, with columns being attributes, or computed/aggregated values from attributes, of relations. For example, a relation/table may have the schema T1 (booktitle, publisher, year). On a particular database state for this schema, the SQL query “SELECT booktitle, year FROM T1 WHERE publisher=‘PRENTICE-HALL’ and year>2000” may produce the following tuples: {<Database Systems, 2001>, <Operating Systems, 2002>, <Computer Networks, 2001>}.

As students are asked to write SQL queries equivalent to English queries, students may submit seemingly different queries that can produce the same results and can in fact be logically equivalent. For instance, the query “SELECT booktitle, year from T1 WHERE year>2000 and publisher=‘PRENTICE-HALL’” is indeed equivalent to the one presented earlier, even though it does not match exactly the earlier query string. Another equivalent query is: “SELECT booktitle, year from T1 WHERE year>=2001 and publisher=‘PRENTICE-HALL’. If the first query presented above is considered the reference query and the second query is submitted by the student, our learning application should correctly ascertain that the submitted query is correct due to their equivalent performance on evaluation data, even though it does not exactly match the reference query string.

In the SQL lab projects, the order of the attributes/columns in the query results may often be unimportant. For instance, the query “SELECT year, booktitle from T1 WHERE publisher=‘PRENTICE-HALL’ and year>2000” is also correct, with respect to the earlier example described above, because the English query for which the SQL query is being developed can state that what needs to be retrieved are the title and the year of publication of the books by PRENTICE-HALL that are published after the year 2000. It may not matter whether the title or the year is the first column in the result produced by the query.

Yet another aspect of checking correctness of SQL queries is the notion of “bag semantics” instead of the “set semantics”. SQL queries produce “bags” of rows that can have the same row appearing multiple times, and not “sets” of rows, which forbid duplicates. For instance, if the database state in the above example table T1 is such that PRENTICE-HALL published two books on Database Systems, perhaps by different sets of authors, in the year 2002, the row <Database Systems, 2002> will appear twice in the query result. There are ways in SQL to eliminate duplicate occurrences of rows in query results (by annotating the SELECT clause with the DISTINCT modifier). The English query in a SQL lab project can very well dictate that the output should not contain duplicate rows, and accordingly the correct/reference query may have the DISTINCT modifier. If the student submits a candidate query that does not have the DISTINCT modifier and therefore produce query results that contain duplicates, our application needs to ascertain such a query as incorrect.

In one embodiment, when a student submits his/her answer, the application executes the reference query and the student's query on a test database and compares the result sets. When comparing the result sets the application checks if each value in the reference result set can be matched by its corresponding occurrence in the submitted query result. The submitted query is declared correct if there is a one-to-one correspondence between the lists of values in the reference query result and the submitted query result.

Logical equivalence issues such as those described in the context of SQL lab projects abound in many other situations. For instance, when students are asked to write a program code segment to compute certain answers or process given parameters, it is possible for several different code segments to be correct. Once again, it is not sufficient to compare the submitted answers in this case with the reference answers in a naive manner and ascertain correctness. The submitted answers have to be interpreted in ways that would allow their correctness to be evaluated properly, like executing the code segments on test data sets. Similarly, given a document type definition (DTD) of extensible markup language (XML), there can be multiple correct XML documents that conform to the DTD. That is, there is no single correct answer to the exercise that requires students to submit conforming XML documents.

Presenting Training Information

When a problem is found with an answer's performance on the evaluation data, the training data is used to provide the user with training information regarding the problem. In the SQL example, the training/evaluation application determines if there are semantic errors using the evaluation data. The application then illustrates semantic errors by presenting sample database states from the training data on which the submitted queries produce incorrect results. In one embodiment, other explanatory material is also presented which further helps the student understand and remediate the problem.

Creating Evaluation And Training Data

In order for instructors to create appropriate training cases and evaluation cases, several techniques may be employed according to the present invention.

In terms of the relationship between the set of test cases and example cases, it is desirable for every relevant failure of the program to be detected by the set of evaluation cases. Similarly, in one embodiment of the invention, there is at least one example training case that also fails (whenever the program is incorrect) and explains the reason for the failure. In some situations, it is desirable to have a one-to-one correspondence between the failed evaluation case and the failed training case, so that when a given program is deemed incorrect because it failed the evaluation case, the corresponding training case that also fails will illustrate and explain the specific reason why the program is incorrect.

However, there are situations in which an evaluation case will fail, but there are multiple underlying possible reasons for the incorrect behavior. Accordingly there can be multiple (i.e., more than one) example cases, each illustrating the various possible causes of the incorrect behavior. It is also possible for there to be a set of root causes for the problems in the submitted program, illustrated by a set of training cases, while at the same time the program correctness itself may be tested by a set of evaluation cases designed to verify input-output behavior (like a set of input stimuli and verifying that the program responds with expected output for each input). Thus, the spirit of the set of training cases in this case is more focused on understanding and illustrating various fundamental pitfalls and causes of incorrectly constructing the program, while the spirit of the set of evaluation cases is more focused on verifying the correctness of the submitted program (no matter what the underlying causes may be). In many situations, these two notions are similar and hence there may be equal numbers of test cases and example cases with a one-to-one corresponding relationship between the two sets of cases.

Explanatory text may also be part of the lab data. In one embodiment, each explanation is linked to at least one example case. When the student's answer does not perform correctly with an evaluation case, one or more corresponding example cases and their respective explanatory text (if any) should be presented to the user.

In the SQL example, in order to illustrate the common errors/mistakes that students make, an instructor specifies multiple sample databases, each illustrating a specific kind of error/mistake that students are expected to make. In addition, the instructor specifies one or more evaluation databases that may test the submitted queries for some or all of the sample errors/mistakes, complex combinations of these cases, and possibly other cases of errors/mistakes.

While constructing evaluation cases that students cannot pass by training their answers based on the feedback they get on the training cases, the key strategy for the instructor is to be able to produce different results for the reference query on the test databases when compared with the sample databases.

In one embodiment, this is done by the training/testing application. In certain fields, it may be possible for rules or transformations, such as those described below, to be developed. Such transformations can be used to generate training cases from evaluation cases automatically. In other cases, the instructor manually sets both the evaluation cases and the training cases.

Example SQL Lab Design

SQL labs give the student a database schema, against which some SQL queries must be written. In a properly designed lab, when the student makes a mistake that is semantic (rather than a syntax error), they are given an example database and shown both what their query did, and what it should have done. In unusual cases, the sample database will fail to exhibit their error, but if the lab designer is careful, that situation will occur rarely.

A pitfall of lab design is that the evaluation database may exhibit an error, i.e., the students query gives a different result from the reference query, yet the example database gives the same result for both queries. Obviously, the evaluation database should have enough tuples, and varied-enough tuples, that the typical incorrect query will do something wrong on that database. However, it is also necessary that errors detected by the evaluation database be shown as well in the example database. Yet if those two databases were the same, the student would immediately know the evaluation database and could just write a query that generated the proper result for that database and no other database.

As an example, a lab using data about the kings and queens of England includes such data in an example database. The data may be written as a sequence of INSERT statements, one for each tuple. A schema is presented to the user which identifies parents as stored in the database in the format: Parent (child, parent).

Next, a copy of the INSERT statements is made from the example database, and certain edits performed on the values in those statements to create the evaluation database. One constraint is that a constant appearing in any of the queries must remain unchanged. Another constraint is that at least some of the constants appearing in any answer must be changed. For example, if an English-language query “Who is the parent of Elizabeth˜II?” is used then ‘Elizabeth˜II’ must not be changed anywhere. However, the name of her father, ‘George˜VI’, should be changed in the evaluation database to avoid allowing a student the “shortcut” of simply writing the query SELECT ‘George VI’ AS parent FROM Parents;

This query would return the correct answer for the testing query, however, it does not embody the requested English-language query. In order to ensure that this query is not graded as correct, global replacement of “George” by another string (which is kept secret from the student) is performed in the evaluation database, and the query which simply returns “George VI” would fail in the evaluation case.

A query that asks for a count may also be tested. For example, consider “How many kings were named Edward?” “Edward” then cannot be replaced by something else in the evaluation database to yield a training database, because a pattern containing ‘Edward’ will appear in the query. However, if no changes involving the “Edward”s are made, the number the student sees in the training database will work in the evaluation database as well. The solution is to either delete some of the Edward tuples in the evaluation database, or add some imaginary Edwards.

Generating Training And Evaluation Cases

In order to generate training cases from evaluation cases (or vice versa) according to one embodiment of the invention, several techniques may be employed.

The first technique alters data in a way which does not materially change the result. For example, in a database context, the data element might be altered without having any effect on the satisfaction of the “query condition” but having an effect on what is output. Data may also be altered in a way that could possibly have an effect on the result, but which is carefully constructed not to. For example, if a query condition tries to find all strings of length at most 8, one string might be changed from length 5 to length 6. Thus the string would still satisfy the condition, however the correct result will not be identical in the two cases.

Data alterations that do change the result may also be used. Thus, if one case includes 5 data elements that satisfy a particular query condition, one of those elements may be changed to not satisfy the query condition (or, alternatively, a sixth data element may be altered to satisfy the query condition.) The result will be a test case that will generally display whether a student's solution has a problem with satisfaction of the query condition but will not be identical to the original case. One case can then be used for testing and another for evaluation.

Generating Training And Evaluation Cases In the Database Context

While the invention is not limited to any specific field as discussed above, the following techniques can be employed in general to generate test databases in this manner:
a) Identify attributes of relations that are in the SELECT clause but not in the WHERE clause of the reference queries. Modify the values of these attributes in the sample databases to arrive at the test databases that will then produce different results. For example, if the reference SQL query is “SELECT booktitle, publisher FROM T1 WHERE year>2000” on the database schema described above, test databases can be generated by modifying the values of the publisher and/or the booktitle attributes in each row of T1. These test databases will generate different query results, which would be hard for a student to “shortcut” correctly solving the problem by identifying.
b) Identify attributes of relations that are in the SELECT clause and are also part of an inequality condition in the WHERE clause. Modify the values of these attributes such that each modification will not change the inequality condition. For example, if the reference SQL query is “SELECT * FROM T1 WHERE year>2000” on the database schema described above, test databases can be generated by modifying the values of the year attribute in such a way that the “year>2000” condition is unaffected. For instance, the row <Database Systems, PRENTICE-HALL, 2002> can be modified to <Database Systems, PRENTICE-HALL, 2004> resulting in different query results.
c) Identify attributes of relations whose values are aggregated in the SELECT clause and which do not appear in the WHERE clause. Modify the values of these attributes such that the modification will actually change the aggregated values. For example, if the reference query is “SELECT publisher, MAX(year) FROM T1 WHERE booktitle=‘Database Systems’”, on the database schema described above, test databases can be generated by modifying the values of the year attribute to actually change the MAX(year) computation. For instance, if the latest year in which PRENTICE-HALL published a book on Database Systems is 2003, the row <Database Systems, PRENTICE-HALL, 2003> should be modified to be <Database Systems, PRENTICE-HALL, 2004>. Note that modifying that row to <Database Systems, PRENTICE-HALL, 2001> does not produce a different query result, if there is also another row <Database Systems, PRENTICE-HALL, 2003> in table T1.
d) Replicate each row in each relation such that each row appears at least twice. Such a state of the test database would catch errors/mistakes related to the “bag semantics” of SQL described above. Alternatively, if a tuple appears several times, all but one copy of the tuple can be deleted.
e) Add an extra tuple to one or more relations in order to produce query answers that are not present in the sample database.

Applicability To Other Application Contexts

The techniques discussed herein in the context of online learning applications are also applicable to online testing systems. For example, in an online interview application, the candidate is presented with a lab project. The he candidate's submitted answers to the lab questions are evaluated, and this evaluation is used to determine the qualifications and proficiency of the candidate in the core skills required for the job.

Extensions

As described above, the techniques described herein are not limited to the case of teaching database systems, but can be used to assist in the teaching of any subject—particularly any programming language or programming-like process (such as a spreadsheet or word processor). The general idea is that the student's answers are applied to two pieces of test data; the results of applying the student's work to one of the pieces of test data can be shown to the student, while the other piece of test data (i.e., the one on which the actual evaluation of the student's work is made) is not revealed to the student. Both sets of test data will preferably reveal the same errors as nearly as possible.

### CONCLUSION

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A method for providing automated training and evaluation of user performance on a problem, comprising:
accepting user solution data to said problem from a user;
applying said user solution data to at least one evaluation case to produce a corresponding user result for each of at least one evaluation cases;
for each of said corresponding user results, evaluating said corresponding user result to determine whether said corresponding user result is acceptable;
for at least one of said evaluation cases, if said corresponding user result is not acceptable, displaying for said user a training case corresponding to said at least one of said evaluation cases, where said training case is calculated to assist said user in understanding said evaluation case.

2. The method of claim 1, further comprising:
for at least one of said evaluation cases, if said corresponding user result is not acceptable, displaying for said user explanatory material pertaining to said evaluation case.

3. The method of claim 1, where said evaluation of said corresponding user result to determine whether said corresponding user result is acceptable comprises:
applying a reference solution to said at least one evaluation cases to produce a corresponding reference result for each of said at least one evaluation cases; and
for each of said at least one evaluation cases, comparing said corresponding reference result to said corresponding user result.

4. The method of claim 1, where said step of, for each of said corresponding user results, evaluating said corresponding user result to determine whether said corresponding user result is acceptable comprises:
comparing said corresponding user result to a stored correct result.

5. The method of claim 1, where said problem comprises a computer-language programming problem, where said solution data comprises computer program data, where each of said evaluation cases comprises input for a computer program, where each of said training cases comprises input for a computer program, and where said user result comprises output from a computer program.

6. The method of claim 5, further comprising:
determining if said computer program data is syntactically correct; and
if said computer program data is not syntactically correct, displaying data regarding said syntactic incorrectness to said user.

7. The method of claim 1, where said problem comprises a database query problem, where said solution data comprises database query data, where each of said evaluation cases and each of said training cases comprises a database.

8. The method of claim 1, where said training case is automatically generated by the application of one or more transformations to said evaluation case.

9. A system for providing automated training and evaluation of user performance on a problem, comprising:
an input for accepting user solution data to said problem from a user;
an application engine for applying said user solution data to at least one evaluation cases to produce a corresponding user result for each of at least one evaluation cases;
a semantic evaluator for, for each of said corresponding user results, evaluating said corresponding user result to determine whether said corresponding user result is acceptable; and
a training output for providing said user data regarding a training case where, for at least one of said evaluation cases, said corresponding user result is not acceptable, where said training case corresponds to said at least one of said evaluation cases.

10. The system of claim 9, further comprising:
a syntactic evaluator for evaluating said user solution data for syntactic correctness; and
a syntactic result output for providing said user data regarding said syntactic evaluation.

11. The system of claim 10 where said syntactic evaluator is a compiler, where said compiler compiles said user solution data, and where said application engine applies said compiled user solution data to said at least one evaluation case.

12. The system of claim 9, where said semantic evaluator applies a reference solution for each of said at least one evaluation cases to produce a corresponding reference result, and compares said corresponding reference result to said corresponding user result.

13. The system of claim 9, where said semantic evaluator compares said corresponding user result to a stored correct result corresponding to said evaluation case.

14. The system of claim 9, where said problem comprises a database query problem, where said solution data comprises database query data, where each of said evaluation cases and each of said training cases comprises a database.

15. A method for training on a computer system, said computer system comprising at least one processing element, comprising:
accepting a user solution to a given computing problem, where said user solution admits of being executed on evaluation data;
executing said user solution on said evaluation data;
identifying at least one problem with said execution; and
displaying for a user training data related to said at least one problem.

16. The method of claim 15, where said at least one problem comprises a syntactic problem and where said user training data comprises compiling errors.

17. The method of claim 15, where said at least one problem comprises a semantic problem with the execution of said user solution on some element of said evaluation data, and where said user training data comprises training data such that an execution of said user solution on said training data replicates said semantic problem.

18. The method of claim 15, where said evaluation data comprises a set of at least one evaluation data elements; where said user training data comprises a set of at least one user training data elements; where each user data element corresponds to one or more of said evaluation data elements; and where said displaying for a user training data related to said at least one problem comprises:
determining a subset of said evaluation data elements related to said at least one problem;
determining a subset of said user training data elements corresponding said evaluation data elements in said subset of said evaluation data elements; and
displaying said subset of said user training data elements for said user.

19. The method of claim 15, where said user training data is automatically generated by the application of one or more transformations to all or part of said evaluation data.
